(19) United States
(12) Patent Application Publication
(10) Pub. No.: US 2009/0151208 A1
(43) Pub. Date: Jun. 18, 2009

(54) SIGN SYSTEM

(76) Inventor: Benjamin L. Garfinkle, Piedmont, CA (US)

Correspondence Address: Bay Area Technolgy Law Group PC, 500 Sansome Street, Suite 404, San Francisco, CA, 94111, US

(21) Appl. No.: 11/956,533

(22) Filed: Dec. 14, 2007

(51) Int. Cl. G09F 3/00

(52) U.S. Cl. 40/299.01; 40/658

(57) ABSTRACT

A sign system that includes a substantially planar sign body having a periphery and a plurality of tabs configured for removably receiving product or price identification indicia. A supplemental sign tag is provided having additional indicia printed thereon, said supplemental sign tag having a slot configured therein. The slot in the supplemental sign tag is sized and positioned to enable a portion of it to be removably inserted within the one of said plurality of tabs such that at least a portion of the additional indicia is visible to an observer external to the periphery of the planar sign. In addition, a clip is provided, attachable to the planar sign body and to the supplemental sign tag to enable the supplemental sign tag to be positioned on a peripheral edge of the planar sign body.

### TECHNICAL FIELD

The present invention deals with a sign system which includes a sign body having a periphery and a plurality of tabs configured for removably receiving product or price identification information. The present invention also includes a supplemental sign tag having additional indicia printed thereon which can be selectively positioned to be received by at least one of the plurality of tabs and, alternatively, to be received by a clip which is configured to receive a portion of the planar sign body as well. Such a sign system provides improved product identification and flexibility heretofore difficult to achieve by prior signage devices.

### BACKGROUND OF THE INVENTION

Retail establishments such as food markets vend upwards of thousands of items displayed on shelves and arranged in aisles. Such products, generally sold at small margin, must be displayed and be associated with signage attracting a customer for differentiating similar products of differing brands or manufacturer. Modern signage must not only passively inform a consumer of the pricing, identification and quantity of a food product, but should have the ability to highlight differentiating characteristics of two seemingly similar products and do so in a way that captures a customer's attention.

In addition to signage being attractive, informative and stimulating, most food markets tend to purchase signage systems whereby product description, pricing and other characterizations can be mixed and matched to minimize maintaining bloated signage inventories.

The present invention, as will be noted in the description which follows, deals with supplemental sign tags providing additional indicia than the principal tags which they are appended. Thus, if a retailer wished to highlight the fact that a certain product was “organic” or “fresh” or has some other attribute or characteristic which would encourage or stimulate a purchase of the item, supplemental tags are often employed to provide this additional information as well as to catch the eye of the consumer as the consumer surveys the myriad of products made available to him.

As an illustration of the prior art approaches to supplemental tags, reference is first made to FIGS. 6A and 6B which show two different styled tags 60 and 61, having “topper” or supplemental signage 65 and 62 respectively held in place by corner tabs 63 and 64 indicating that the products being sold are on special or “as advertised.” It should be noted that in each instance, in using toppers 65 and 62, the arrows can only be used diagonally from an upper right to lower left orientation unless the arrow topper was to be printed with the same information on both sides to enable it to be flipped 180 degrees. This limits the versatility of such a topper, a situation which the present invention is intended to remedy. In practicing the present invention, various toppers or supplemental signage could be printed with different messages on each side of the signage while not being concerned with the limitations inherent in the examples shown in FIGS. 6A and 6B.

A similar limitation can be appreciated by viewing FIG. 7. In this instance, signage 71 can again be made the platform for receiving topper or supplemental signage 72 as shown held in place by corner tabs 74. However, because this sign includes graphics in top portion 73, supplemental signage can only be placed in the corner tabs as indicated. In other words, such signage cannot be placed atop sign 71 in upper most region 73 as it would block the supplemental graphics. Again, as will be more appreciate it in the description of the present invention which follows, such a limitation is not an obstacle in practicing the present invention.

It is thus an object of the present invention to provide a signage system which informs and attracts customers and yet which can be made part of a signage system that does not require the inventorying of dedicated product signage which cannot be used in describing a variety of goods.

This and further objects will be more readily apparent when considering the following disclosure and appended claims.

### SUMMARY OF THE INVENTION

The present invention is directed to a sign system comprising a substantially planar sign body having a periphery and plurality of tabs configured for removably receiving product and price identification indicia, a supplemental sign tag having additional indicia printed thereon, said supplemental sign tag having a slot configured therein, said slot being sized and positioned to enable a portion of said supplemental sign tag to be removably inserted within said one of said plurality of tabs such that at least a portion of said additional indicia is visible to an observer external to the periphery of said planar sign. The supplemental sign tag is also capable of being positioned on a peripheral edge of said planar sign body through the use of a clip as described hereinafter particularly when suitable tabs are unavailable for receiving the supplemental sign tag.

### BRIEF DESCRIPTION OF THE FIGURES

FIG. 1 is a front planar view of a planar sign body of the prior art useful in practicing the present invention.

FIG. 2 is a front plan view of a supplemental sign tag for use herein.

FIGS. 3A and 3B are front plan and side views, respectively, of a clip for use in one of the embodiments of the present invention in connecting the supplemental sign tag of FIG. 2 to the planar sign body of FIG. 1.

FIG. 4 is a perspective view of a first embodiment of the present invention.

FIG. 5 is a perspective view of a second embodiment of the present invention.

FIGS. 6A, 6B and 7 are front plan views of prior art signage related to the present invention.

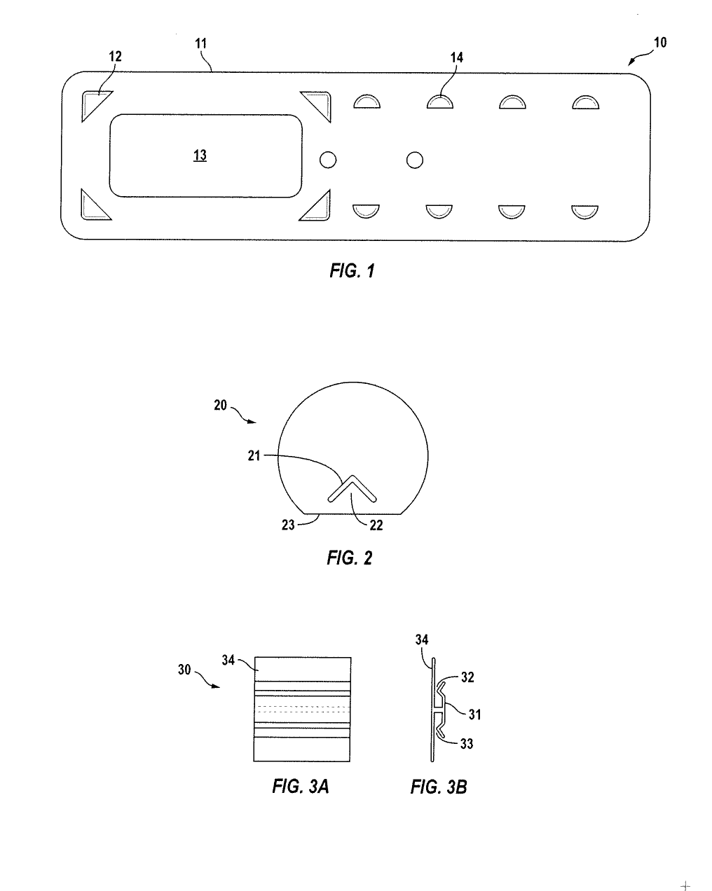

### DETAILED DESCRIPTION OF THE INVENTION

Planar sign 10 has been used in identifying products in food market environments. Such signage can be positioned through the use of a number of various support systems, none of which constitute a part of the present invention. Nevertheless, it is worth mentioning that signage 10 can be placed in a typical C-channel located on the outer edge of a product support shelf or it can be placed on an easel base or similar stand.

Signage 10 includes a plurality of tabs 12 and/or 14. When in use, product identifying inserts can be placed within, for example, the four corner tabs 12 to present such information through or over window 13. Such signage could be employed without window 13 in which case product identification information would be displayed in the blank field now shown as window 13. Signage employed without product tabs or window is shown in FIG. 5. Associated pricing information can be inserted within, for example, tabs 14, thus providing a consumer with information regarding an associated product on display. However, as noted previously, it is oftentimes necessary to provide a consumer with additional information supplementing the information provided in using planar sign 10 and, to that end, reference is made to FIG. 2. An example of such a system could be employed wherein planar sign 10 might be associated with the sale of salmon while the retailer wishes to inform a consumer in a bold and forthright fashion that the salmon is “wild” rather than “farm raised.” Signage could also be supplemented to indicate that a particular product is “organic” or has some other characteristic which would make it particularly appealing to a consumer.

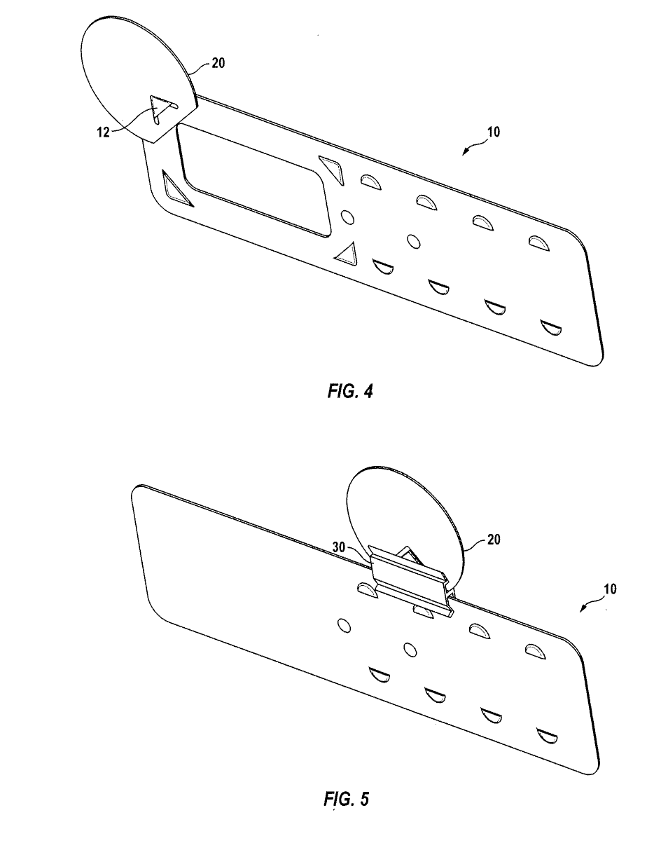

Such additional information can be provided without changing the basic nature of planar sign 10 by providing supplemental sign tag 20. Supplemental sign tag 20 is provided with a slot or die cut slit 21 positioned to enable portion 22 to extend within, for example, tab 12 as noted in reference to FIG. 4. It should be recognized that slot or slit 21 configured within supplemental sign tag 20 ideally comprises a V-shaped slit as noted in FIG. 2 and is insertable within tab 12 by bending supplemental sign tag 20 to project portion 22, that portion being receivable by tab 12, again, as depicted in FIG. 4.

The present sign system provides a user with an alternative orientation regarding the support of supplemental sign tag 20 upon planar sign body 10. This provides a user, such as a store clerk, with the ability to position supplemental sign tag 20, if tab 12 was not available to engage it. Also, there are instances where it would be more appropriate to append supplemental sign tag 20 to a peripheral edge, such as edge 11 of planar side body 10 rather than projecting supplemental sign tag 20 in a somewhat diagonal orientation such as shown in FIG. 4. In this regard, reference is made to FIGS. 3A, 3B and 5.

The sign system of the present invention, as a second embodiment, further comprises clip 30 having a front face 34 and rear clip portion 31 creating first portion 33 for receiving a portion of planar sign body 10 and second portion 32 to receive supplemental sign tag 20. When clip 30 is employed, ideally, edge 23 of supplemental sign tag 20 is linear or flat to enhance a stable engagement with clip 30 again, as shown in FIG. 5, while the remaining periphery of supplemental sign tag 20 can be curved, as shown.

In use, a store clerk need only inventory a single planar sign body 10, a plurality of supplemental sign tags 20 and clips 30. As a further illustration of how the present invention can be employed, one could use planar sign body 10 to advertise the sale of produce, such as lettuce. Without changing either the product identifying information or its price, a store clerk could reach into an inventory of supplemental sign tags 20 to indicate, when appropriate, that the produce was “organic” or “fresh.”

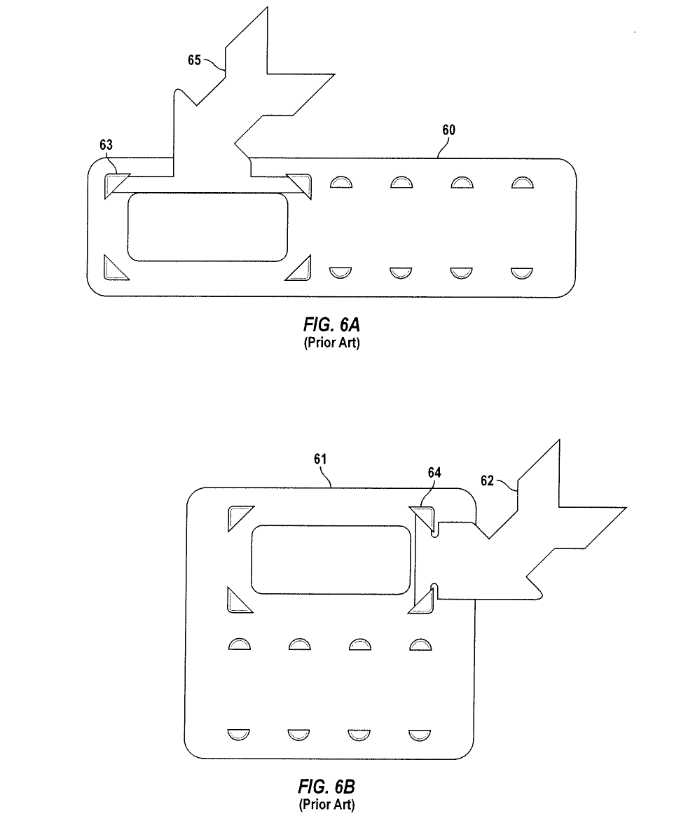

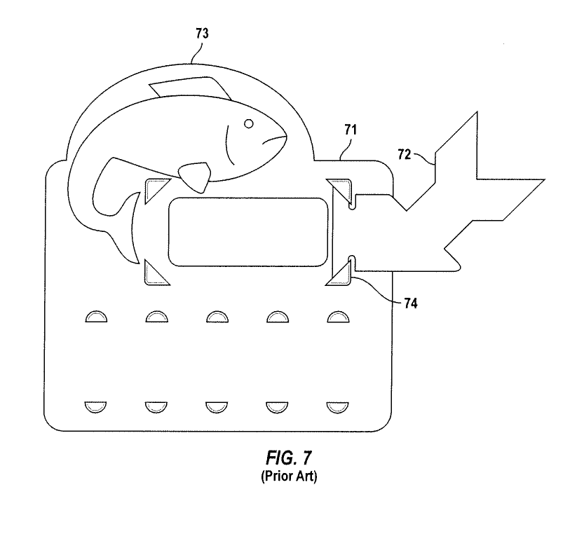

In addition, it should be quite apparent that the sign system of the present invention enables one to position a supplemental sign either in any of the four corners represented by tabs 12 or as a topper along edge 11. This removes the limitations inherent in those examples shown in FIGS. 6A, 6B and 7. Appropriate signage can be printed with different messages on either side and yet a user of the present invention need not be limited in the orientation of the supplemental signage in taking advantage of alternative messaging or supplemental signage positioning.

1. A sign system comprising a substantially planar sign body having a periphery and a plurality of tabs configured for removably receiving product or price identification indicia, a supplemental sign tag having additional indicia printed thereon, said supplemental sign tag having a slot configured therein, said slot being sized and positioned to enable a portion of said supplemental sign tag to be removably inserted within one of said plurality of tabs such that at least a portion of said additional indicia is visible to an observer external to the periphery of said planar sign.

2. The sign system of claim 1 further comprising a clip, first portion of which being sized to receive a portion of said planar sign body at said periphery and a second portion of which being configured to receive a portion of said supplemental sign tag.

3. The sign system of claim 2 wherein said supplemental sign tag is configured to have a portion of its periphery substantially linear, said linear portion of said periphery being that portion to be received by said clip.

4. The sign system of claim 3 wherein that portion of said supplemental sign tag not configured to be received by said clip is substantially curved.

5. The sign system of claim 1 wherein said slot configured within said supplemental sign tag comprises a V-shaped slit insertable within at least one of said plurality of tabs by bending said supplemental sign tag to project a portion of it at said V-shaped slit, that portion being receivable by one of said tabs.

6. A sign system comprising a substantially planar sign body having a plurality of price identification tabs configured for removably receiving price identification indicia and, further comprising product identification tabs configured for removeably receiving product identification indicia, a supplemental sign tag having additional indicia printed thereon, said supplemental sign tag having a slot configured therein, said slot being sized and positioned to enable a portion of said supplemental sign tag to be removably inserted within said one of said optional product identification tabs when such tabs are included within said planar sign such that at least a portion of said additional indicia is visible to an observer external to the periphery of said planar sign, said sign system further comprising a clip, a first portion of which is sized to receive a portion of said planar sign body at said periphery and a second portion of which being configured to receive a portion of said supplemental sign tag such that said supplemental sign tag can be received by at least one of said plurality of product identification tabs when such tabs are included within said planar body and by said second portion of said clip when said product identification tabs are not included within said planar body.

7. A sign system of claim 6 wherein said supplemental sign tag is configured to have a portion of its periphery substantially linear, said linear portion of said periphery being that portion received by said clip.

8. The sign system of claim 7 wherein that portion of said supplemental sign tag not configured to be received by said clip is substantially curved.

9. The sign system of claim 6 wherein said slot configured within said supplemental sign tag comprises a V-shaped slit, insertable within at least one of said plurality of tabs by bending said supplemental sign tag to project a portion of it at said V-shaped slit, that portion being received by one of said tabs.
